(19) United States
(12) Patent Application Publication
(10) Pub. No.: US 2013/0008677 A1
(43) Pub. Date: Jan. 10, 2013

(54) MULTI-HEAD POWER TOOL

(76) Inventor: CHEN HUIFU, Ningbo (CN)

(21) Appl. No.: 13/197,850

(22) Filed: Aug. 4, 2011

Related U.S. Application Data
(60) Provisional application No. 61/505,628, filed on Jul. 8, 2011.

(51) Int. Cl. B25F 5/02; B23P 17/00

(52) U.S. Cl. 173/29; 29/401.1

(57) ABSTRACT

A handheld power tool that includes a base portion and one or more head portions that are designed to be removably connectable to the base portion. The base portion includes a base housing, an electric motor at least partially positioned in the base housing, a power supply removably connected to the housing, a top connection arrangement. The head portion includes a head housing, a first gear assembly, a second gear assembly, and a head connection arrangement. The first gear assembly has a first shaft that is rotatably positioned about a first longitudinal axis and a second gear assembly having a second shaft that is rotatable about a second longitudinal axis. The first and second longitudinal axis of the two gear assemblies are non-parallel to one another.

The present invention claims priority on U.S. Provisional Application Ser. No. 61/505,628 filed Jul. 8, 2011, which is incorporated herein by reference.

The present invention is directed to power tools, more particularly to a power tool having interchangable attachments, still more particularly to a power tool having interchangable head attachments, and still yet more particularly to a hand-held power tool having angled interchangable head attachments, and still yet more particularly to a battery operated hand-held power tool having angled interchangable head attachments.

### BACKGROUND OF THE INVENTION

Power tools such as rotary motor-based tools are commonly used for many different tasks such as cutting, bolting, boring, sanding, hammering, stripping, drilling, grinding, and the like.

There are a variety of power tools that can be used with a number of different attachments. There is also a variety of power tools that have angled attachments. These power tools are commonly hand-held power tools having an electric motor that rotates a motor shaft at high speeds. One type of power tool such as an electric drill includes a conventional drill-type chuck or a collet-type system mounted on the end of the motor shaft outside of the motor housing. The drill-type chuck or a collet-type system is used to connect drill bits and other types of attachments to the motor shaft.

Traditional power tools are designed to rotate a drill bit and other type of attachment about an axis that is parallel to the rotation axis of the motor shaft of the motor. The utility of a power tool can be enhanced by attaching various accessories to the motor shaft. The use of such attachments expand the utility of the power tool. However, the utility of such attachments may be limited if such attachments are attached directly to the end of the motor shaft. In such a case, the orientation of the attachment with respect to the motor housing may inhibit effective use of the power tool due to limited orientation, control and visibility.

Various attachments have been proposed for use on a standard power drill. Such attachments are often complex in design and do not properly connect to the various shaped and sized power drills. Also, the size, shape and weight of standard power drills can make a task difficult or impossible.

In view of the current state of the art of power tools, there remains the need for a handheld power tool that is simple and convenient to operate, which can be easily connected to various attachments, and which can operate the various attachments at an orientation that is non-parallel to the axis of the motor shaft of the power tool.

### SUMMARY OF THE INVENTION

The present invention is directed to handheld tools, more particularly to handheld power tools having one or more angled head interchangable attachments. The handheld power tool can be battery powered (e.g., 12V, 14V, 16V, 18V, 20V, 22V, 24V, etc.) and/or powered via an electrical outlet. When the handheld power tool is battery operated, the battery can be a rechargeable battery; however, this is not required. The handheld power tool has a base or body portion and a head attachment portion that can be connected and disconnected from one another. The one or more electric motors are generally positioned in the base or body portion; however, this is not required. When the power tool is battery powered, the battery is generally located in and/or connectable to the base or body portion; however, this is not required. In one non-limiting embodiment, the rechargeable battery is detachably connectable to the base or body portion of the power tool. Such an arrangement enables a replacement battery to be inserted into the base or body portion of the power tool while another battery is being charged. The size, shape, voltage and amperage of the one or more batteries, when used, are non-limiting. The shape and size of the base or body portion of the power tool is non-limiting. Also, the colors and materials used to form the base or body portion of the power tool is non-limiting. Generally, the base or body portion of the power tool is non-limiting and will include an actuator to enable a user to activate and deactivate the electric motor. As can be appreciated, the actuator can alternatively be located on the head portion. The power tool can include more than one actuator; however, this is not required. The shape and type of actuator is non-limiting. Also, the location of the one or more actuators on the power tool is non-limiting. The base or body portion of the power tool can optionally include one or more gripping materials and/or be ergonomically designed to facilitate in the holding and/or handling of the power tool during use. The size, shape, color and materials for the head portion is also non-limiting. The power tool can be designed for use with one or more different head portions. When two or more head portions are designed for use with the base or body portion of the power tool, the bottom region of the head portions is generally the same or similar so that the different head portions can be connected to the base or body portion of the power tool. When more than one head portion is designed for use with the base or body portion of the power tool, the different head portions can be designed to perform different functions (e.g., impact screwdriver tool, angle drilling tool, ratchet wrench tool, light attachment, saw blade tool, metal/wood cutting tool, sander, hammer, etc.).

In one non-limiting aspect of the present invention, at least one of the head portions of the power tool have an angled arrangement relative to the motor axis of the motor in the base or body portion when the head portion is connected to the base or body portion. The angled arrangement includes a first gear assembly having a first shaft and a first gear, and a second gear assembly including a second shaft and a second gear. The first and second gear assembly are designed to directly or indirectly engage with one another. The central longitudinal axis of the first gear assembly is non-parallel to the central longitudinal axis of the second gear assembly. Generally, the central longitudinal axis of the first gear assembly has an angle relative to the central longitudinal axis of the second gear assembly of about 1°-179°, typically about 10°-180°, and more typically about 15°-175°. The angle of the central longitudinal axis of the first gear assembly to the central longitudinal axis of the second gear assembly can be a fixed angle or a variable angle. In one non-limiting embodiment of the invention the angle of the central longitudinal axis of the first gear assembly to the central longitudinal axis of the second gear assembly is fixed at about 90°. In another non-limiting embodiment of the invention the angle of the central longitudinal axis of the first gear assembly to the central longitudinal axis of the second gear assembly is fixed at about 30°. In another non-limiting embodiment of the invention the angle of the central longitudinal axis of the first gear assembly to the central longitudinal axis of the second gear assembly is fixed at about 45°. In another non-limiting embodiment of the invention the angle of the central longitudinal axis of the first gear assembly to the central longitudinal axis of the second gear assembly is fixed at about 60°. In another non-limiting embodiment of the invention the angle of the central longitudinal axis of the first gear assembly to the central longitudinal axis of the second gear assembly is fixed at about 120°. In another non-limiting embodiment of the invention the angle of the central longitudinal axis of the first gear assembly to the central longitudinal axis of the second gear assembly is fixed at about 150°.

In another and/or alternative non-limiting aspect of the present invention, the head portion is designed to be connected at a plurality of orientations about the longitudinal axis of the base or body portion of the power tool. The ability of the head portion to be positioned at different locations about the longitudinal axis of the base or body portion of the power tool increases the versatility of the power tool when performing various functions. In one non-limiting embodiment of the invention, the head portion is designed to be connected at two different orientations about the longitudinal axis of the base or body portion of the power tool. Generally, these two orientations are about 180° apart from one another as determined relative to the longitudinal axis of the base or body portion of the power tool. In another non-limiting embodiment of the invention, the head portion is designed to be connected at three different orientations about the longitudinal axis of the base or body portion of the power tool. Generally, these three orientations are about 120° apart from one another as determined relative to the longitudinal axis of the base or body portion of the power tool. In another non-limiting embodiment of the invention, the head portion is designed to be connected at four different orientations about the longitudinal axis of the base or body portion of the power tool. Generally, these four orientations are about 90° apart from one another as determined relative to the longitudinal axis of the base or body portion of the power tool.

In still another and/or alternative non-limiting aspect of the present invention, the head portion and the base or body portion of the power tool are designed to be quick connected together to enable quick and simple attachment and quick and simple detachment of the head portion to/from the base or body portion of the power tool. In one non-limiting embodiment of the invention, the bottom or lower region of the head portion and the upper or top region of the base or body portion of the power tool are configured to enable the head portion to be inserted downwardly onto the base or body portion and thereafter twisted to lock the head portion onto the base or body portion. The power tool can optionally include a locking arrangement that prevents the head portion from inadvertently disengaging from the base or body portion once the head portion has been properly and fully connected to the base or body portion. The locking arrangement, when used, can optionally be designed to prevent operation of the electric motor if the head portion has not been properly and fully connected to the base or body portion. The configuration of the locking arrangement, when used, is non-limiting.

In summary, the present invention is directed to a handheld power tool that includes a base portion and a head portion. The base portion includes abuse housing, an electric motor at least partially positioned in the base housing, a base coupling arrangement that is designed to rotate about a base longitudinal axis when the motor is activated, and a top connection arrangement. The head portion includes a head housing, a first gear assembly at least partially positioned in the head housing, a second gear assembly at least partially positioned in the head housing, a head connection arrangement, and a tool coupler designed to connect a tool to the head portion. The first gear assembly has a first shaft that is positioned along a first longitudinal axis and a first gear coupling arrangement designed to engage the base coupling arrangement when the head portion is connected to the base portion. The first shaft is designed to rotate about the first longitudinal axis. The base coupling arrangement is designed to cause the first shaft to rotate when the first gear coupling is engaged to the base coupling arrangement and the base coupling arrangement rotates. The first and second gear assemblies are connected or interconnected together such that rotation of the first shaft of the first gear assembly results in rotation of a second shaft of the second gear assembly. The second shaft is designed to rotate about a second longitudinal axis. The first and second longitudinal axis of the two gear assemblies are non-parallel to one another. The top connection arrangement of the base portion is designed to be releasably connected to the head connection arrangement of the head portion. In another and/or alternative non-limiting arrangement, the head portion is connectable to the base portion in a plurality of finite positions about the base longitudinal axis. The number of head positions is non-limiting. Generally the number of head positions are 2-10 positions, and typically 2-4 positions and more typically 4 positions. Adjacently positioned head positions are generally spaced at an equal distance from one another; however, this is not required. In another and/or alternative non-limiting arrangement, the top connection arrangement includes a plurality of slots that are designed to receive a plurality of connection tabs of the head connection arrangement when the head portion is connected to the base portion. The number of connection tabs is generally equal to or less than the number of slots. The number of slots is generally equal to or greater than the number of head positions that are available on the base portion. Adjacently positioned slots are generally spaced at an equal distance from one another; however, this is not required. Adjacently positioned connection tabs are generally spaced at an equal distance from one another; however, this is not required. In another and/or alternative non-limiting arrangement, the slot configuration of the top arrangement causes the connection tabs of the head connection arrangement to move downwardly in the slots and also causes the connection tabs to move sideways in the slots when the head portion is connected to the base portion thereby causing the head portion to move both downwardly along the base longitudinal axis and to rotate only partially about the base longitudinal axis. In another and/or alternative non-limiting arrangement, the slot configuration is generally L-shaped. In another and/or alternative non-limiting arrangement, a releasable retention tab is included that locks the head portion in position on the base portion after the connection tabs have at least partially moved sideways in the slots. The retention tab can be located on the base portion or the house portion. In another and/or alternative non-limiting arrangement, a plurality of different head portions are designed to be connected to different types of tools and to perform different functions. The head connection arrangement on each of the different head portions is substantially the same so that the different head portions can be interchangeably connected to the base portion. In another and/or alternative non-limiting arrangement, the first and second longitudinal axis are at about 90° to one another.

It is one non-limiting object of the present invention to provide a power tool that includes one or more detachable head portions for connection onto a base portion.

It is another and/or alternative object of the present invention to provide a power tool that includes an easy and simple arrangement to attach and detach a head portion on/off the base portion of the power tool.

It is still another and/or alternative object of the present invention to provide a power tool that includes an attachment arrangement that enables a head portion of the power tool to be connected to the base portion of the power tool at a plurality of locations about the longitudinal axis of the base portion.

It is yet another and/or alternative object of the present invention to provide a power tool that includes a plurality of head portions that can be connected to and removed from the base portion of the power tool, and wherein each of the head portions performs a different function.

It is still yet another and/or alternative object of the present invention to provide a power tool that includes a head portion that can be attached and detached to a base portion of the power tool, and which head portion includes a first and second gear assembly, and wherein the first gear assembly is designed to be connected to or interconnected to a motor shall in the base portion of the power tool when the head portion is connected to the base portion, and wherein the longitudinal axis of the first and second gear assemblies are non-parallel to one another.

It is another and/or alternative object of the present invention to provide a power tool that includes a safety connector to maintain the head portion on the base or body portion of the power tool.

It is still another and/or alternative object of the present invention to provide a power tool that is a handheld power tool.

It is yet another and/or alternative object of the present invention to provide a power tool that includes an electric powered motor and is powered by a removable rechargeable battery.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various preferred embodiments that the invention may take in physical form and in certain parts and arrangement of parts wherein:

FIG. 1 is a side elevation view of the power tool in accordance with the present invention showing the head portion connected to the base portion;

FIG. 2 is a side elevation view of the head portion of the power tool illustrated in FIG. 1;

FIG. 3 is a side elevation view of another head portion of the power tool in accordance with the present invention that can be connected to the base portion of the power tool that is illustrated in FIG. 1;

FIG. 4 is a side elevation view of another head portion of the power tool in accordance with the present invention that can be connected to the base portion of the power tool that is illustrated in FIG. 1;

FIG. 5 is a side elevation view of another head portion of the power tool in accordance with the present invention that can be connected to the base portion of the power tool that is illustrated in FIG. 1;

FIG. 6 is a prospective elevation vie of the base portion of the power tool that is illustrated in FIG. 1;

FIG. 7 is an opposite side elevation view of the base portion of the power tool that is illustrated in FIG. 1 which illustrates the removable battery pack detached from the base portion of the power tool;

FIG. 8 is a rear side elevation view of the base portion of the power tool of FIG. 1, wherein the head lock switch is in the lock position;

FIG. 9 is portion of the rear side elevation view of the base portion of the power tool of FIG. 1, wherein the head lock switch is in the unlock position;

FIG. 10 is across-sectional view along line 10-10 of FIG. 8;

FIG. 11 is a bottom elevation view of the head portion of the power tool of FIG. 1;

FIG. 12 is a top plan view of the base portion of the power tool of FIG. 1 and illustrates the movement of the head portion in broken lines during the insertion or removal of the head portion form the base portion;

FIG. 13, is a bottom plan view of the head portion of the power tool of FIG. 1; and,

FIG. 14 is a partial cross-sectional view of the power tool showing the connection of the head portion to the base portion of the power tool.

### DETAILED DESCRIPTION OF THE PREFERRED EMBODIMENTS

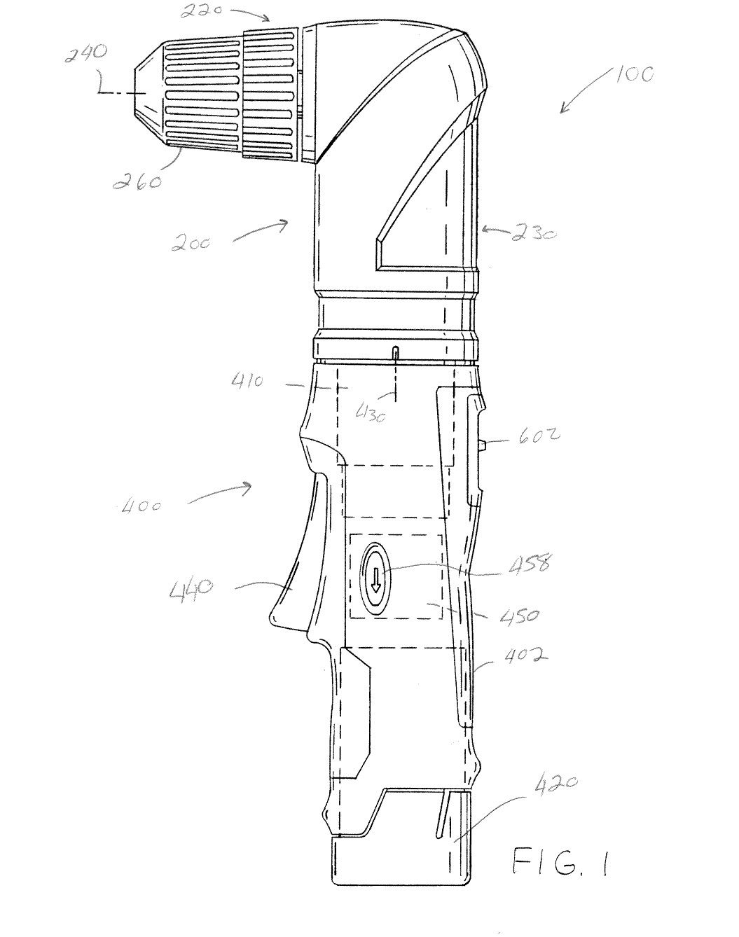

Referring now to the drawings wherein the showings are for the purpose of illustrating a preferred embodiment of the invention only and not for the purpose of limiting same, FIGS. 1-14 illustrate one non-limiting embodiment of the power tool 100 in accordance with the present invention. The power tool includes a head portion 200 and a base portion 400. The materials, color and shape of the head and base portion are non-limiting. Generally the materials used to form the head and base portion are lightweight and durable (e.g., hard plastic or another polymeric material, metal, composite materials, etc.). The outer housing of the head portion and the base portion are generally fully or partially formed of an electrically insulating material. The housing of the head portion and/or the base portion can be formed of one or more parts. When two or more parts are used, the parts can be connected together in a variety of ways (e.g., adhesives, fasteners such as rivets, screws or nut and bolt type assemblies, snap together assembly, etc.).

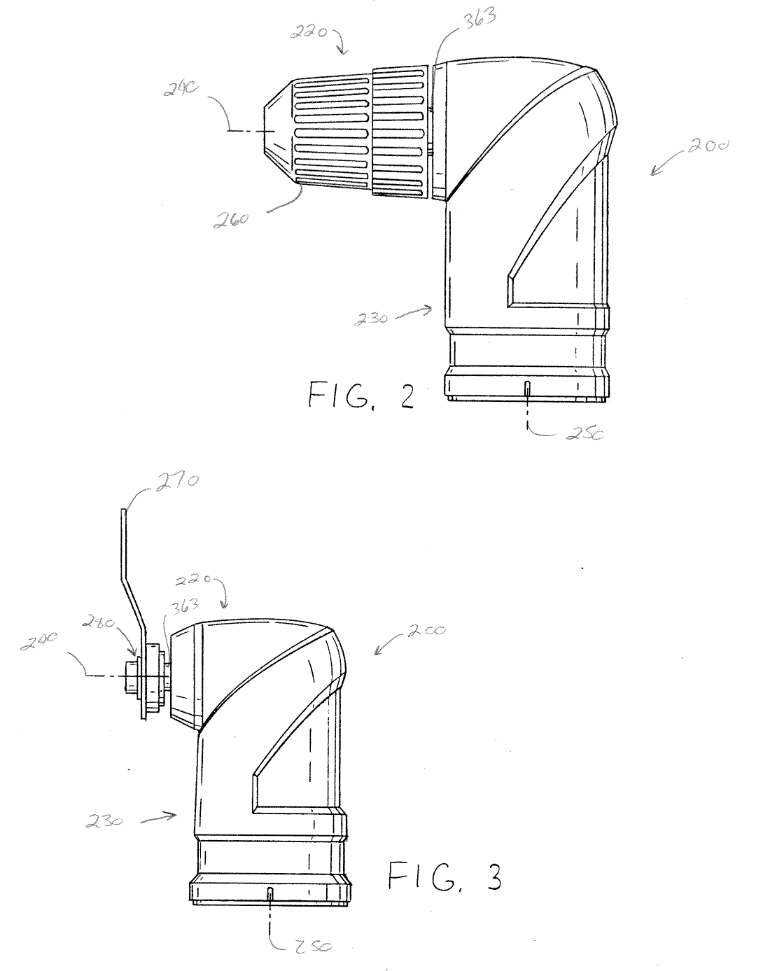

The head portion includes an upper region 220 and a lower region 230. The lower region of the head portion is designed to connect to the base portion as will be described in more detail below. The base portion can be designed to be connected to different head portions so as to increase the versatility of the power tool; however, this is not required. Non-limiting examples of different types of head portions are illustrated in FIGS. 2-5. For each of the different head portions, the lower region of the head portion is the same or similar so that such different head portions can be connected to the same base portion of the power tool. The longitudinal axis 240, 250 of the upper region 220 and a lower region 230, respectively for each of the head portions is illustrated as being non-parallel to one another. The angle between longitudinal axes 240, 250 is generally 10°-170°, typically 45°-135°, and more typically about 90°.

The head portion illustrated in FIG. 2 is a drilling tool head that is generally designed to be used with various types of bits, not shown, such as drill bits, screw bits and the like. The head portion includes collet locking device 260 used to secure a bit to the head portion. The head portion is designed to cause the bit that is secured by the collet locking device to rotate clockwise or counterclockwise about longitudinal axis 240. In one non-limiting arrangement, the collet locking device includes a 0.25 inch, ⅜ inch or 0.5 inch chuck so as to hold a wide variety of bits; however, the drilling tool head can be designed to have different sized chucks. The drilling tool can be designed to change out the collet locking device so as to have a different chuck size; however, this is not required. The torque generated by the drilling tool head is generally about 60-180 in. lbs.; however, the drilling tool head can be designed to generate other torque values. The rotational speed is generally about 0-1000 rpm; however, the drilling tool head can be designed to generate other rotational speeds.

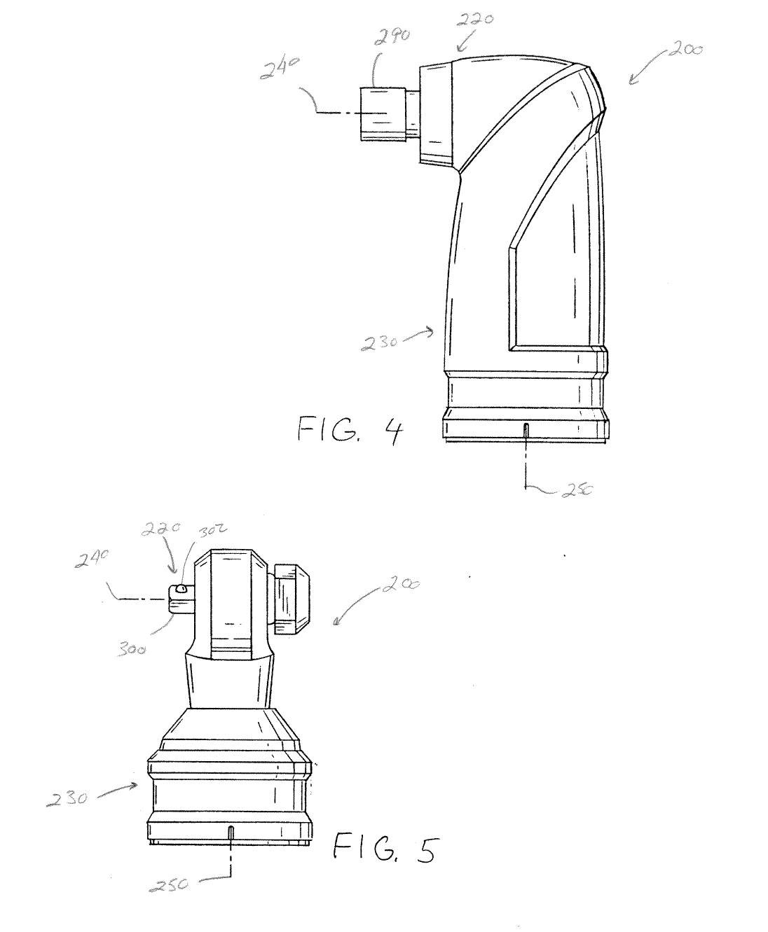

The head portion illustrated in FIG. 3 is a multi-function tool head. This tool head is designed to be connected to various types of tool devices (e.g., sanding pad, saw blade, cutting blade, scraper blade, etc.). A cutter blade 270 is illustrated as the tool device connected to the upper region of the head portion by a connection arrangement 280. Any number of different connection arrangements can be used to secure the tool device to the upper region of the head portion (e.g., bolt, screw, clamp, etc.). The tool device that is secured to the upper region of the head portion is able to be rotated clockwise or counterclockwise about longitudinal axis 240. In one non-limiting arrangement, the rotational speed is generally about 0-30,000 rpm; however, the multi-function tool head can be designed to generate other rotational speeds.

The head portion illustrated in FIG. 4 is an impact screwdriver tool head. This tool head is designed to be connected to screwdriver bits and the like. The bits are connected to the upper region of the head portion by a connection arrangement 290. Any number of different connection arrangements can be used to secure the a tool device to the upper region of the head portion (e.g., collet locking device, fixed head to a bit, etc.). The bit that is secured to the upper region of the head portion is able to be rotated clockwise or counterclockwise about longitudinal axis 240. In one non-limiting arrangement, the connection arrangement includes a 0.25 inch, ⅜ inch or 0.5 inch hex quick coupler; however, the impact screwdriver tool head can be designed to have different types of couplers. The impact screwdriver tool head can be designed to change out the connection arrangement; however, this is not required. The torque generated by the impact screwdriver tool head is generally about 100-1000 in. lbs.; however, the impact screwdriver tool head can be designed to generate other toque values. The rotational speed is generally about 0-3000 rpm; however, the impact screwdriver tool head can be designed to generate other rotational speeds.

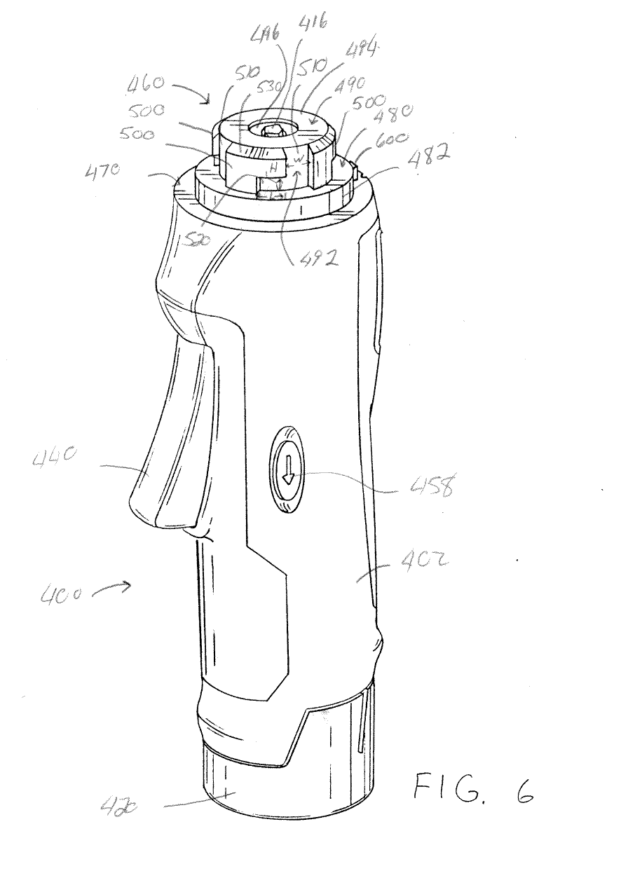

The head portion illustrated in FIG. 5 is a ratchet wrench tool head. This tool head is designed to be connected to various sized and shaped sockets. The sockets are connected to the upper region of the head portion by a socket connector 300. The socket connector includes a depressible contact that facilitates in maintaining the socket on the socket connector. The socket that is secured to the upper region of the head portion is able to be rotated clockwise or counterclockwise about longitudinal axis 240. In one non-limiting arrangement, the socket connector includes a 0.25 inch, ⅜ inch or 0.5 inch square ratchet connector so as to hold a wide variety of sockets; however, the ratchet wrench tool head can be designed to have different sized and/or shaped ratchet connectors. The ratchet wrench tool head can be designed to change out the ratchet connector so as to have a different sized and/or shaped ratchet connector; however, this is not required. The torque generated by the ratchet wrench tool is generally about 60-500 in. lbs.; however, the ratchet wrench tool can be designed to generate other toque values. The rotational speed is generally about 0-500 rpm; however, the ratchet wrench tool can be designed to generate other rotational speeds.

As can be appreciated, other tool heads can be used with the power tool to perform additional functions (e.g., hammer tool head, oscillating tool head, etc.).

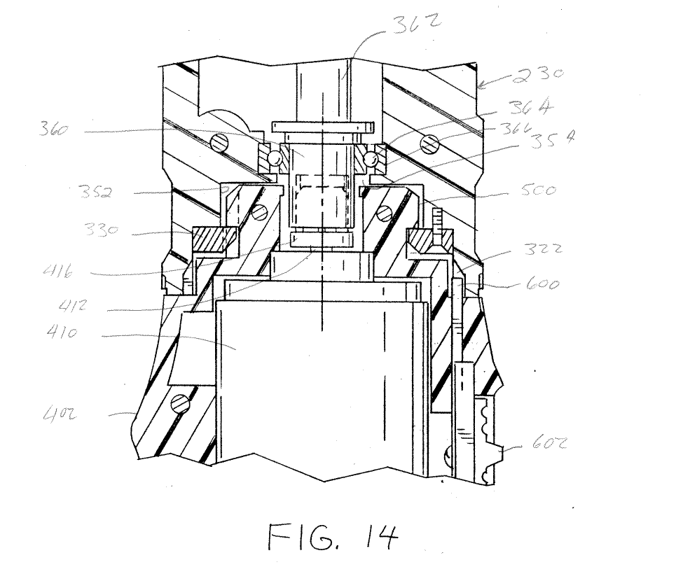

Each of the tool heads illustrated in FIGS. 2-5 include first and second first gear assemblies. The first gear assembly is positioned on or generally parallel to longitudinal axis 250 of lower region 230. The second gear assembly is positioned on or generally parallel to longitudinal axis 240 of upper region 220. The first gear assembly is designed to engage or interengage with the drive shaft of a motor located in the base portion of the power tool when the head portion is connected to the base portion. The first and second gear assemblies are designed to engage or interengage with only one another. One or more gears can be used to engage or interengage the first and second gear assemblies. In each of the head portions illustrated in FIGS. 2-5, the first gear assembly is designed to rotate about longitudinal axis 250 of lower region 230 or an axis that is parallel to longitudinal axis 250, and the second gear assembly is designed to rotate about longitudinal axis 240 of upper region 220 or an axis that is parallel to longitudinal axis 240. The configuration and one or more components that form the first and second gear assemblies are non-limiting. Each of the gear assemblies generally includes a shaft that rotates about the longitudinal axis of the gear assembly. FIG. 14 illustrates shaft 362 of the first gear assembly and FIGS. 2 and 3 illustrate shaft 363 of the second gear assembly.

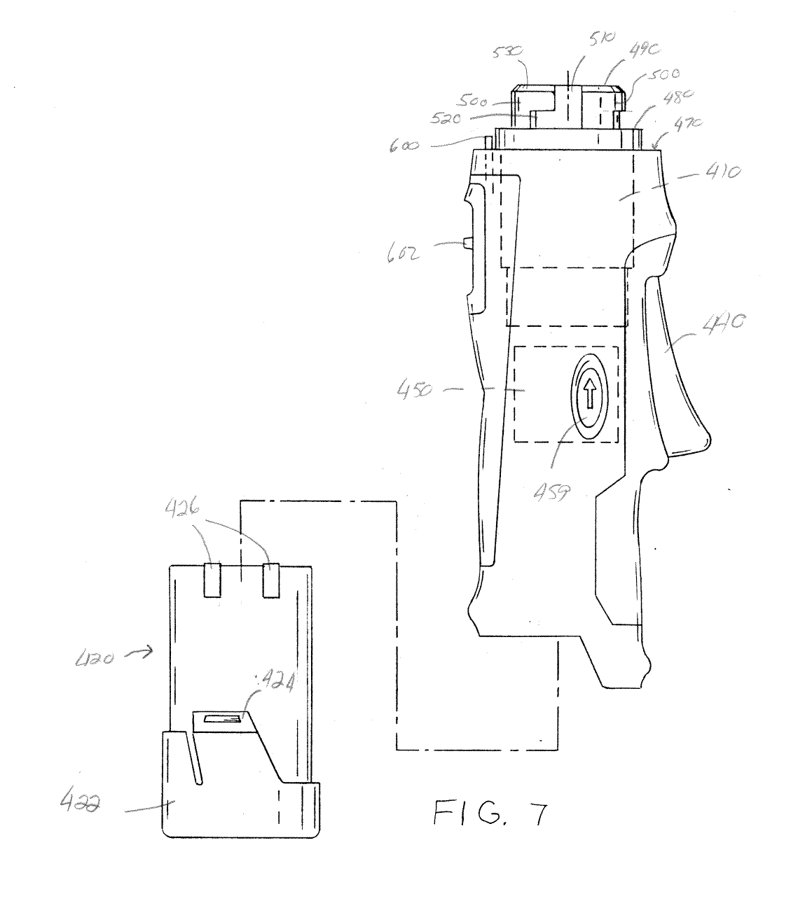

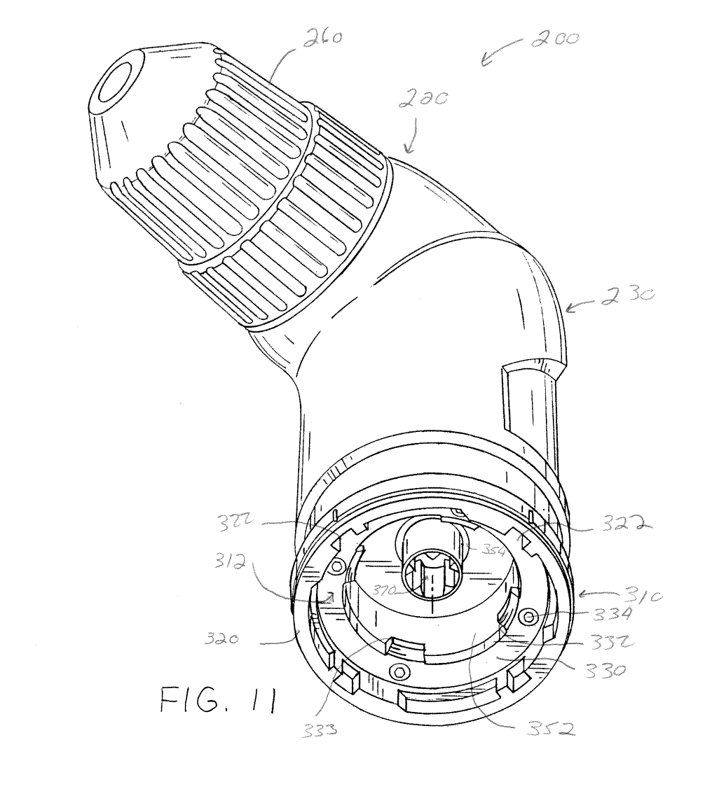

Referring now to FIGS. 1 and 6-10, the base portion 400 is configured to be gripped in a user's hand. Many different configurations of the base portion can be used. Generally, the base portion includes an electric motor 410 and a battery power supply 420. The motor is generally position within the base portion such that the motor shaft 412 lies on central longitudinal axis 430 of the base portion or on an axis that is parallel to longitudinal axis 430. The size, shape and power of the motor is non-limiting. Generally the electric motor is a 0.5-5 amp motor; however, other sizes can be used. The base portion includes an actuator in the form of a depressible switch 440. The depressible switch can be used to activate and deactivate motor 410. The depressible switch can also be used to control the speed of the motor; however, this is not required. As illustrated in FIG. 10, the depressible switch 440 engages a movable button 452 on controller 450. Controller 450 is used to control the flow of current from battery 420 to motor 410. Such current flow control can be used to activate the motor, deactivate the motor, control the rotation speed of the motor, and/or control the rotation direction (e.g., clockwise rotation, counterclockwise rotation) of the motor. Power cables 454 are used to conduct current from the battery to the controller. Power cable 456 are used to conduct current from the controller to the motor. The configuration and circuitry in controller 450 is non-limiting. Controller 450 can optionally include a safety switch 458 that can be used to prevent operation of the motor even when switch 440 is depressed by a user. Alternatively or additionally, switch 458 can be used to control the rotation direction of the motor. Also, a switch 459 can be used in conjunction with or separately from switch 458. As illustrated in FIGS. 7 and 10, switch 458 includes a downwardly facing arrow and switch 459 includes an upwardly facing arrow. The power tool can be designed so that when one switch is depressed by a user, the motor rotates in one direction and when the other switch is depressed by a user, the motor rotates in the opposite direction; however, this is not required. For example, the depressing of the switch having the upwardly facing arrow results in the motor rotating in the clockwise direction when switch 440 is depressed by a user, and the depressing of the switch having the downwardly facing arrow results in the motor rotating in the counterclockwise direction when switch 440 is depressed by a user. Switches 458 and/or 459 can optionally include an intermediate position that causes the motor to not operate when switch 440 is depressed by a user. The size, configuration and/or operation of switches 458, 459 are non-limiting. Switch 440 is illustrated as being pivotally connected to the housing 402 of the base portion by a pivot connector 442. As can be appreciated, switch 440 can be designed to be moved in other or alternative ways (e.g., a slide switch, etc.). The size, configuration and operation of switch 440 is non-limiting. Also, the manner in which switch 440 engages or interacts with controller 450 to cause the motor to activate, deactivate and/or control the speed of the motor and/or rotation direction of the motor is non-limiting.

Referring now to FIG. 7, battery 420 is illustrated as being removable from housing 402 of the base portion. The battery housing 422 can include a depressible locking arrangement 424 that is designed to engage housing 402 of the base portion when the battery is inserted into the battery cavity of the housing of the base portion. As can be appreciated, other or additional arrangements can be used to enable the battery to be secured to and be detached from the housing of the base portion. The configuration of the battery is non-limiting. Likewise, the configuration of the portion of the housing of the base portion designed to receive the battery is non-limiting. The battery is generally a 10V, 12V, 14V, 18V, or 22V battery; however, other types of batteries can be used. The battery is generally a rechargeable battery; however, this is not required. Generally, only one battery is connected to housing 402 of the base portion at one time; however, this is not required. The battery is illustrated as including electrical contacts 426 that enable current to pass from the battery to power cables 454.

As illustrated in FIG. 1, when head portion 200 is connected to base portion 400, the central longitudinal axis 430 of the base portion is aligned with or parallel to the central longitudinal axis 250 of the lower portion of the head portion. The specific arrangement for connecting and disconnecting the head portion from the base portion is illustrated in FIGS. 6-14. The connection arrangement is designed to enable the head portion to be connected to the base portion in more than one position about the longitudinal axis 430 of the base portion; however, this is not required. Generally, the connection arrangement is designed to enable the head portion to be connected to the base portion in 2, 3 or 4 different positions about the longitudinal axis 430 of the base portion; however, it can be appreciated that the connection arrangement can be designed to enable the head portion to be connected at more than 4 different positions about the longitudinal axis of the base portion. These different positions are generally equally spaced apart from one another about the longitudinal axis 430 of the base portion; however, this is not required. For example, when the connection arrangement is designed to enable the head portion to be connected at two different positions about the longitudinal axis of the base portion, the two positions are at about 180° angles from one another about the longitudinal axis of the base portion. The connection arrangement illustrated in FIGS. 6-14 shows a connection arrangement is designed to enable the head portion to be connected at four different positions about the longitudinal axis of the base portion, thus the four positions are at about 90° angles from one another about the longitudinal axis of the base portion.

Referring now to FIGS. 6-10 and 12, the base portion 400 includes atop connection region 460. The top connection region 460 includes a base landing 470, an intermediate landing 480, and top landing 490. The intermediate landing is spaced inwardly from and spaced above the base landing. The cross-sectional shape of the intermediate landing is circular. The intermediate landing wall 482 is generally oriented to be perpendicular to the top surface of the base landing; however, it can be appreciated that all or a portion of the intermediate landing wall can be tapered or shaped in other configurations between the top surface of the intermediate landing and the top surface of the base landing. The top landing is spaced inwardly from and spaced above the intermediate landing. The cross-sectional shape of the top landing is circular. The top landing wall 492 is generally oriented to be perpendicular to the top surface of the intermediate landing; however, it can be appreciated that all or a portion of the top landing wall can be tapered or shaped in other configurations between the top surface of the intermediate landing and the top surface of the top landing.

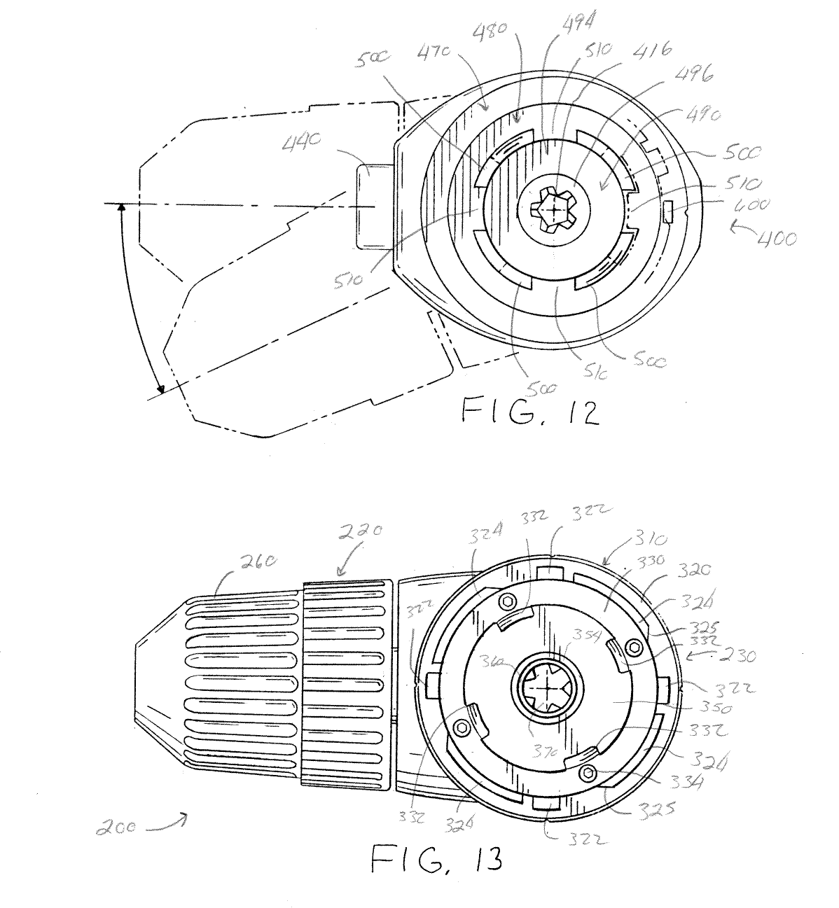

As illustrated in FIG. 12, four lock structures 500 are positioned on the outer surface of top landing wall 492 and adjacently positioned lock structures are generally equally spaced from one another about the outer surface of the top landing wall. A vertical lock slot 510 and a horizontal lock slot 520 are formed by two adjacent positioned lock structures. The combined vertical lock slot and a horizontal lock slot have a general L-shape; however, this is not required. The width W of the vertical lock slot is illustrated as being greater than the height H of the horizontal lock slot; however, this is not required. Generally, width W is about 10-250% the height H of the horizontal lock slot. When the width W of the vertical lock slot is the same or greater than the height H of the horizontal lock slot, width W is about 100-200% the height H of the horizontal lock slot, typically 100-175% the height H of the horizontal lock slot, and more typically about 100-150% the height H of the horizontal lock slot. As illustrated in FIG. 6, width W of vertical lock slot is about twice (200%) the height H of the horizontal lock slot. Also, the length L of the horizontal lock slot can be the same or different from the width W of the vertical lock slot. Generally, width W is about 10-250% the length L of the horizontal lock slot. When the width W of the vertical lock slot is the same or less than the length L of the horizontal lock slot, width W is about 50-100% the length L of the horizontal lock slot, typically 75-100% the length L of the horizontal lock slot, and more typically about 80-100% the length L of the horizontal lock slot. As illustrated in FIG. 6, width W of vertical lock slot is about the same (100%) as the length L of the horizontal lock slot.

The shape of the horizontal lock slot and vertical lock slot are designed to require the head portion to be both downwardly moved toward the base landing 470 and also be rotated about the longitudinal axis of the base portion to connect the head portion to the base portion. As can be appreciated, many lock slot configurations can be used to require the head portion to be both downwardly moved toward the base landing 470 and also be rotated about the longitudinal axis of the base portion to connect the head portion to the base portion. The shape of the horizontal lock slot and vertical lock slot illustrated in FIGS. 6-10 and 12 are designed to require the head portion to be first downwardly moved toward the base landing 470 and thereafter rotated about the longitudinal axis of the base portion to connect the head portion to the base portion. As can be appreciated, the shape of the horizontal lock slot and vertical lock slot can be designed to require the head portion to be partially downwardly moved toward the base landing and thereafter partially rotated about the longitudinal axis of the base portion in a plurality of steps as the head portion is connected to the base portion, or both simultaneously require the head portion to be downwardly moved toward the base landing and partially rotated about the longitudinal axis of the base portion as the head portion is connected to the base portion. The shape of the horizontal lock slot and vertical lock slot illustrated in FIGS. 6-10 and 12 are designed to require the head portion to be rotated clockwise after the head portion is moved downwardly moved toward the base landing 470 when securing the head portion to the base portion; however, it can be appreciated that the shape of the horizontal lock slot and vertical lock slot can be designed so that the head portion is rotated counterclockwise after the head portion is moved downwardly moved toward the base landing when securing the head portion to the base portion. When the head portion is to be removed from the base portion, the steps to remove the head portion are reversed from the steps to insert the head portion on the base portion.

The top edge 530 of the lock structures has a downwardly sloped surface that is used to facilitate in the insertion of the head portion on the base portion. The sloped surface is an optional feature of the lock structures.

The top surface 494 of the top landing 490 includes a central opening 496 that is generally positioned about the central axis 430 of the base portion; however, this is not required. The central opening has a generally circular shape; however, this is not required. The opening provides access to a motor connection chamber 414 that partially or fully contains drive connector 416. Drive connector 416 is connected to motor shaft 412 and is designed to rotate with motor shaft 412.

Referring now to FIGS. 11 and 13, the bottom of the lower region 230 of the head portion 200 includes a bottom connection region 310 that is designed to engage with and connect with the top connection region 460 of the base portion. The bottom connection region includes a connection cavity 312 that is designed to telescopically receive all or a portion of the top connection region 460 of the base portion when the head portion is connected to the base portion.

The bottom connection region includes a bottom landing 320 that defines the bottom surface of the base portion. The bottom landing is designed to contact or be positioned closely adjacent to the base landing 470 of the base portion when the head portion is connected to the base portion. The bottom landing includes four retention slots 322. The adjacently positioned retention slots are positioned at generally equal distances from one another as illustrated in FIG. 13. The retention slots are used in conjunction with retention tab 600 on the base portion to lock the head portion on the base portion. The retention tab is designed to move into one of the four retention slots based on the position of the head portion relative to the base portion once the head portion is fully inserted onto the base portion. The retention tab 600 is moved upwardly and downwardly by a tab switch 602 that is positioned on the outer surface of the housing 402 of the base portion. As can be appreciated, switch 602 can be located in a number of different locations on the base portion. The size and configuration of the switch is non-limiting. The switch is illustrated as being spring biased by spring 604 so that the retention tab is biased on the upward locked position; however, this is not required. The bottom landing 320 also optionally includes four guide slots 324 that are designed to guide the retention tab 600 to one of the retention slots 322 when the head portion is rotated on the base portion while the head portion is being connected to the base portion. The adjacently positioned guide slots are positioned at generally equal distances from one another as illustrated in FIG. 13. The size, length and configuration of the retention slots and the guide slots are non-limiting. The depth of the guide slots is illustrated as being less than the depth of the retention slots; however, this is not required. The width of the retention slot is generally a little greater than the width of the retention tab so that the retention tab can fit into the retention slot. The guide slot can optionally include a tapered region 325 to facilitate in the movement of the retention tab from the guide slot to the retention slot.

The bottom connection region includes a lock landing 330 that is spaced inwardly from the bottom landing 320. The inward spacing is generally the same as the height of intermediate landing wall 482. Lock landing 330 is designed to contact or be positioned closely adjacent to the intermediate landing 480 of the base portion when the head portion is connected to the base portion. Lock landing 330 includes four lock tabs 332. The lock tabs are designed to be inserted into one of the vertical lock slots 510 and then subsequently moved into a corresponding horizontal lock slot 520 when the head portion is connected to the base portion. The width of the lock tabs is generally less than the width W of the vertical lock slots and the thickness of the lock tabs is generally less than the height H of the horizontal lock slots 520. The adjacently positioned lock tabs are positioned a generally equal distance apart from one another about the lock landing as illustrated in FIG. 13. The lock tabs can optionally include sloped surfaces 333 as illustrated in FIG. 11 to facilitate in the movement of the lock tabs into the horizontal lock slots. The lock landing optionally can be detachably connected in the connection cavity 312 by one or more connection members 344; however, it can be appreciated that the lock landing can be permanently formed in or connected to the connection cavity.

The bottom connection region includes a end landing 350 that is spaced inwardly from the lock landing 330. The inward spacing is generally the same as the height of top landing wall 492. Base landing 350 is designed to contact or be positioned closely adjacent to the top landing 490 of the base portion when the head portion is connected to the base portion. The end wall 352 that surrounds the end landing and extends downwardly from the end landing has a generally circular cross-section shape and has a diameter that is large enough to enable the end wall to be positioned about the four lock structures 500 on the base portion when the head portion is portioned on the base portion. The base landing also includes an opening 354 that is designed to enable a gear drive connector 360 of the first gear assembly to through the opening. As can be appreciated, the gear drive connector can be recessed in or flush with opening 354. The gear drive connector is designed to engage the drive connector 416 on the base portion when the head portion is connected to the base portion as illustrated in FIG. 14.

As illustrated in FIG. 14, when the gear drive connector engages drive connector 416 on the base portion once the head portion is connected to the base portion, the motor 410, when activated, causes the motor shaft 412 to rotate, which in turn causes the drive connector to rotate, which in turn causes the gear drive connector 360 to rotate. The gear drive connector is connected to a shaft 362 of the first gear assembly in the head portion. The rotation of the gear drive connector causes the shaft to rotate. Bearings 364 and bushings 366 can optionally be used to facilitate in the proper rotation of shaft 362. As can be appreciated, other or additional arrangements can be used to facilitate in the proper rotation of shaft 362 and/or to maintain the shaft in the proper position in the head portion. As stated above, the first gear assembly is connected or interconnected to the second gear assembly in the head portion. The rotation of shaft 362 of the first gear assembly causes the rotation, pulsation and/or oscillation of one or more components of the second drive assembly. The gear drive connector 360 includes a connector cavity 370 that is designed to telescopically receive all or a portion of drive connector 416. The shape of cavity 360 is generally star shaped as illustrated in FIG. 13; however, many different cavity shapes can be used (e.g., polygonal, oval, etc.). The shape of the cavity is non-limiting. The shape of the drive connector generally has a shape that is designed to correspond closely to the shape of cavity 360 so that the drive connector can fit into and engage with the gear drive connector once the head portions is connected to the base portion. As illustrated in FIG. 12, the drive connector also has a generally star shaped configuration; however, the shape of the drive connector is non-limiting. The upper portion of the drive connector can optionally includes a tapered portion 417 as illustrated in FIG. 10 to facilitate in the insertion of the drive connector into the cavity of gear drive connector 360.

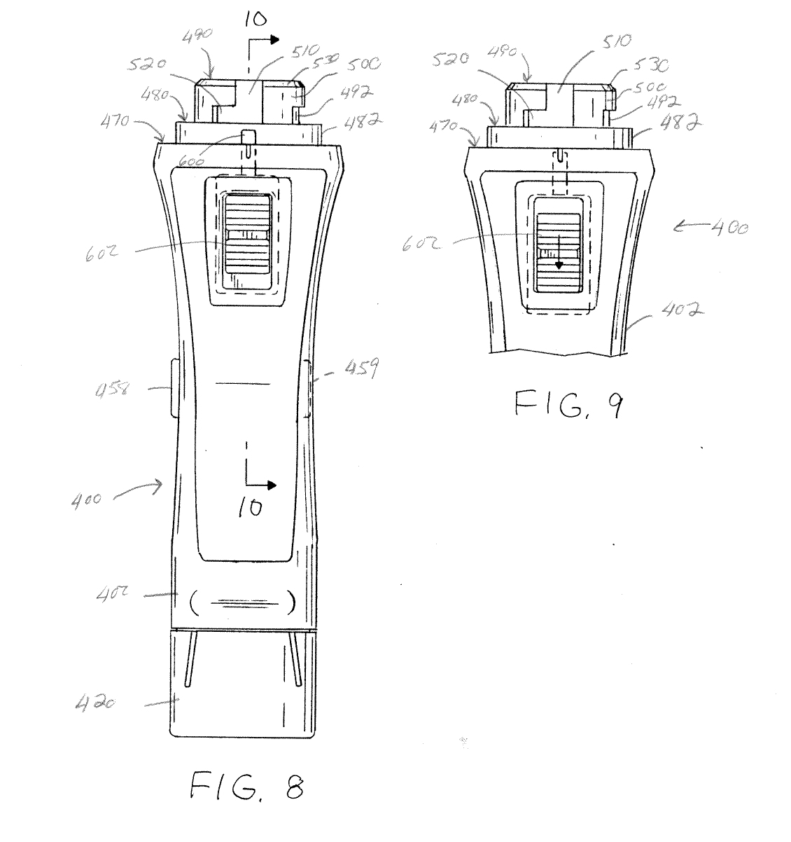

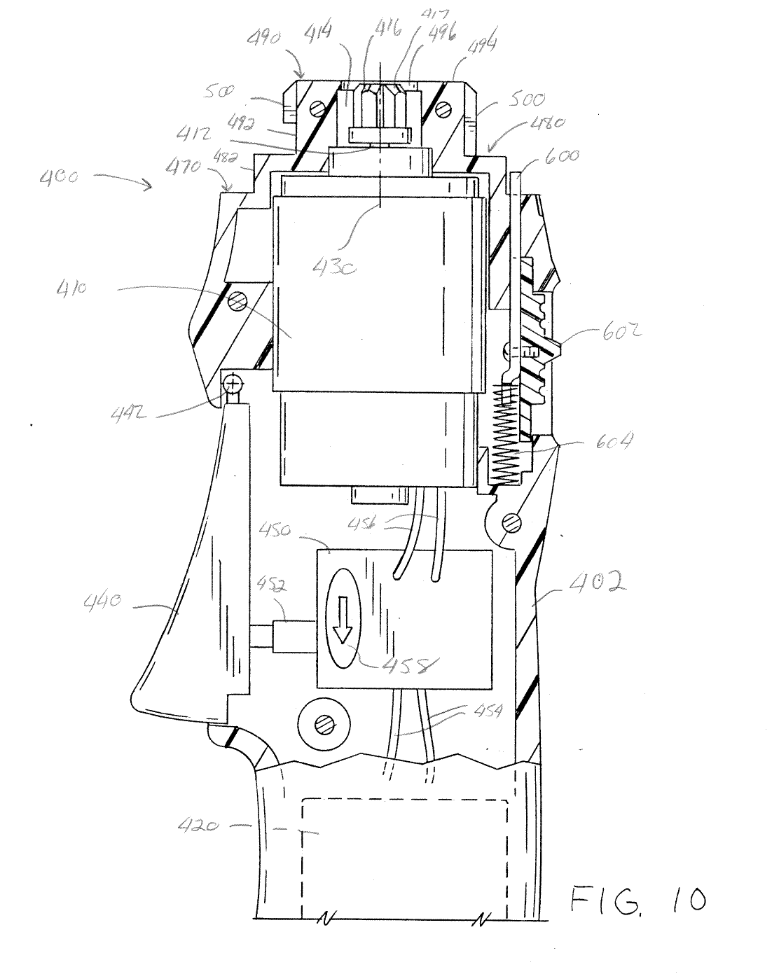

Referring now to FIGS. 8, 9, 12 and 14, the operation of inserting and removing the head portion onto/from the base portion will be briefly described. When preparing the power tool 100 for use, the user must first select the proper head portion that will be used to perform the desired job. As illustrated in FIGS. 2-5, four different head portions are illustrated that are used to perform different types of functions. As can be appreciated, other head portions that perform other functions can be used. Once the desired head portion is selected, the connection cavity 312 on the bottom connection region 310 of the head portion is inserted onto the top connection region 460 of the base portion. The head portion, prior to be connected to the base portion is oriented about axis 430 of the base portion until the head portion is oriented in a desired position relative to the base portion. As discussed above, the base portion as illustrated in FIG. 12 enables the head portion to be oriented in four different positions about axis 430. Once the head portion is properly oriented, the head portion is moved downwardly onto the base portion so that the four lock tabs 332 move into the four vertical lock slots 510. As the head portion is moved downwardly onto the base portion, the gear drive connector 360 engages and connects to the drive connector 416. Once the four lock tabs have moved fully down into the vertical lock slots, the head portion is rotated as illustrated by the dashed lines in FIG. 12 to cause the four lock tabs to move into four horizontal lock slots 520. Once the four lock tabs are fully moved into the four horizontal lock slots, the retention tab 600 moves into one of the retention slots 322 to thereby lock the head portion on the base portion. Once the head portion is locked to the base portion, switches 458, 459 can be selected to determine the rotation direction of the motor. The motor can be activated by pressing switch 440 to thereby cause a portion of the head portion to rotate, pulse, oscillate, etc. When the head portion is to be removed, switch 602 is moved downwardly as indicated by the arrow in FIG. 9 to cause the retention tab to move downwardly so as to release from retention slot 322. Thereafter, the head portion can be rotated and then lifted off of the head portion.

Although not shown, one or more lights (e.g., LED light, etc.) can be included on the housing of the base portion and/or on the head portion to provide light during the use of the power tool. When one or more lights are included in the base portion and/or head portion, a light switch located on the head portion and/or base portion can be used to activate/deactivate the light. The power tool can optionally include a level indicator on the head portion and/or base portion to facilitate in the use of the power tool. The head portion and/or the base portion can optionally include one or more gripping arrangements (e.g., rubber component, non-smooth surfaces, ergonomic configurations, etc.) to facilitate in the handling and use of the power tool. The power tool can include one or more safety stop features to prevent activation of the motor. One non-limiting stop feature can be associated with switches 458, 459 or some other switch whereby when the switch is positioned in a certain position the motor will not activate and/or switch 440 cannot be depressed. Another and/or additional stop feature can be when the retention tab is not in the fully up position, the motor cannot be activated. As such, if the head portion is not properly or fully connected to the base portion, the retention tab may be in a non-fully up position, thereby preventing operation of the power tool until the head portion is properly inserted onto the base portion. As can be appreciated, other or additional stop features can be used.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

I claim:

1. A handheld power tool comprising a base portion and a head portion, said base portion including a base housing, an electric motor at least partially positioned in said base housing, a base coupling arrangement that is designed to rotate about a base longitudinal axis when said motor is activated, and a top connection arrangement, said head portion including a head housing, a first gear assembly at least partially positioned in said head housing, a second gear assembly at least partially positioned in said head housing, a head connection arrangement, and a tool coupler designed to connect a tool to said head portion, said first gear assembly having a first shaft that is positioned along a first longitudinal axis and a first gear coupling arrangement designed to engage said base coupling arrangement when said head portion is connected to said base portion, said first shaft designed to rotate about said first longitudinal axis, said base coupling arrangement designed to cause said first shaft to rotate when said first gear coupling is engaged to said base coupling arrangement and said base coupling arrangement rotates, said first and second gear assemblies connected or interconnected together such that rotation of said first shaft of said first gear assembly results in rotation of a second shaft of said second gear assembly, said second shaft designed to rotate about a second longitudinal axis, said first and second longitudinal axis non-parallel to one another, said top connection arrangement of said base portion designed to releasably connect to said head connection arrangement of said head portion.

2. The power tool as defined in claim 1, wherein said head portion is connectable to said base portion in a plurality of finite positions about said base longitudinal axis, said number of positions selected from the group consisting of two positions, three positions, four positions, five positions, six positions, seven positions, eight positions, nine positions, and ten positions.

3. The power tool as defined in claim 1, wherein said top connection arrangement includes a plurality of slots that are designed to receive a plurality of connection tabs of said head connection arrangement when said head portion is connected to said base portion.

4. The power tool as defined in claim 3, wherein said slot configuration of said top arrangement causes said connection tabs of said head connection arrangement to move downwardly in said slots and to also cause said connection tabs to move sideways in said slots when said head portion is connected to said base portion thereby causing said head portion to move both downwardly along said base longitudinal axis and to rotate only partially about said base longitudinal axis.

5. The power tool as defined in claim 4, wherein said slot configuration is generally L-shaped.

6. The power tool as defined in claim 4, including a releasable retention tab that locks said head portion in position on said base portion after said connection tabs have at least partially moved sideways in said slots.

7. The power tool as defined in claim 1, including a plurality of different head portions designed to be connected to different types of tools and to perform different functions, said head connection arrangement of said head portions substantially the same so that said different head portions can be interchangeably connected to said base portion.

8. The power tool as defined in claim 1, wherein said first and second longitudinal axis are at about 90° to one another.

9. A handheld power tool comprising a base portion and a head portion, said head portion is connectable to said base portion in up to four finite positions about said base longitudinal axis that are about 90° from one another about said base longitudinal axis, said base portion including a base housing, an electric motor at least partially positioned in said base housing, a base coupling arrangement that is designed to rotate about a base longitudinal axis when said motor is activated, a power source that is detachably connected to said base housing, and a top connection arrangement, said head portion including a head housing, a first gear assembly at least partially positioned in said head housing, a second gear assembly at least partially positioned in said head housing, a head connection arrangement, and a tool coupler designed to connect a tool to said head portion, said top connection arrangement including a plurality of slots that are designed to receive a plurality of connection tabs of said head connection arrangement when said head portion is connected to said base portion, said slot configuration of said top arrangement causing said connection tabs of said head connection arrangement to move downwardly in said slots and also causing said connection tabs to move sideways in said slots when said head portions is connected to said base portion thereby causing said head portion to move both downwardly along said base longitudinal axis and to rotate only partially about said base longitudinal axis, said first gear assembly having a first shaft that is positioned along a first longitudinal axis and a first gear coupling arrangement designed to engage said base coupling arrangement when said head portion is connected to said base portion, said first shaft designed to rotate about said first longitudinal axis, said base coupling arrangement designed to cause said first shaft to rotate when said first gear coupling is engaged to said base coupling arrangement and said base coupling arrangement rotates, said first and second gear assemblies connected or interconnected together such that rotation of said first shaft of said first gear assembly results in rotation of a second shaft of said second gear assembly, said second shaft designed to rotate about a second longitudinal axis, said first and second longitudinal axis are at about 90° to one another, said top connection arrangement of said base portion designed to releasably connect to said head connection arrangement of said head portion.

10. The power tool as defined in claim 9, wherein said top connection arrangement includes four slots that are designed to receive four connection tabs of said head connection arrangement when said head portion is connected to said base portion.

11. The power tool as defined in claim 10, wherein said slot configuration is generally L-shaped.

12. The power tool as defined in claim 9, including a releasable retention tab that locks said head portion in position on said base portion after said connection tabs have at least partially moved sideways in said slots.

13. The power tool as defined in claim 9, including a plurality of different head portions designed to be connected to different types of tools and to perform different functions, said head connection arrangement of said head portions substantially the same so that said different head portions can be interchangeably connected to said base portion.

14. A method of customizing a handheld power tool for a particular operation comprising:
providing a base portion of said handheld power tool, said base portion including a base housing, an electric motor at least partially positioned in said base housing, a base coupling arrangement that is designed to rotate about a base longitudinal axis when said motor is activated, and a top connection arrangement;
providing one or more head portions, each of said head portions including a head housing, a first gear assembly at least partially positioned in said head housing, a second gear assembly at least partially positioned in said head housing, a head connection arrangement, and a tool coupler designed to connect a tool to said head portion, said first gear assembly having a first shaft that is positioned along a first longitudinal axis and a first gear coupling arrangement, said first shaft designed to rotate about said first longitudinal axis, said second gear assembly having a second shaft that is positioned along a second longitudinal axis, said first and second gear assemblies connected or interconnected together such that rotation of said first shaft of said first gear assembly results in rotation of a second shaft of said second gear assembly, said first and second longitudinal axis non-parallel to one another;
selecting a head portion that is designed to perform a desired function;
orienting said head portion relative to said base portion prior to connecting said head portion to said base portion, said head portion designed to be releasably connectable to said base portion in up to four different finite positions about said base longitudinal axis;
connecting said selected head portion to said base portion, said first gear coupling arrangement designed to engage said base coupling arrangement when said head portion is connected to said base portion, said base coupling arrangement designed to cause said first shaft to rotate when said first gear coupling is engaged to said base coupling arrangement and said base coupling arrangement rotates, said top connection arrangement of said base portion designed to releasably connect to said head connection arrangement of said head portion, said top connection arrangement including a plurality of slots that are designed to receive a plurality of connection tabs of said head connection arrangement when said head portion is connected to said base portion, said slot configuration of said top arrangement causing said connection tabs of said head connection arrangement to move downwardly in said slots and to also causing said connection tabs to move sideways in said slots when said head portion is connected to said base portion thereby causing said head portion to move both downwardly along said base longitudinal axis and to rotate only partially about said base longitudinal axis.

15. The method as defined in claim 14, including a releasable retention tab that locks said head portion in position on said base portion after said connection tabs have at least partially moved sideways in said slots.

16. The method as defined in claim 14, wherein said first and second longitudinal axis are at about 90° to one another.
